(19) United States
(12) Patent Application Publication
(10) Pub. No.: US 2008/0270686 A1
(43) Pub. Date: Oct. 30, 2008

(54) METHODS AND SYSTEM TO CACHE CONTENT ON A VEHICLE

(76) Inventors: Michael F. Grannan, Austin, TX (US); Lalitha Suryanarayana, Austin, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/740,700

(22) Filed: Apr. 26, 2007

(51) Int. Cl. G06F 12/00

(52) U.S. Cl. 711/113

(57) ABSTRACT

A system and methods of caching content on a vehicle are disclosed herein. One method comprises identifying a passenger for an upcoming ride on the vehicle, identifying content of interest to the passenger, and transmitting at least a portion of the content of interest to a storage device carried by the vehicle for caching prior to a beginning of the ride.

### FIELD OF THE DISCLOSURE

This disclosure relates generally to content distribution, and, more particularly, to methods and system to cache content on a vehicle.

### BACKGROUND

In recent years, vehicles such as commercial airliners have been adding network access for voice and data communications during transit. These communication links to the vehicle have been either links to satellite connections or links to wireless ground-based towers. These communication links have limited bandwidth and are able to transfer only a limited amount of data, voice, and/or multimedia content to the vehicle. Moreover, the limited bandwidth available via these communications links must be split between uploading and downloading data. The limited bandwidth issue is further exacerbated for vehicles such as aircraft with a large numbers of passengers vying for use of the same communication links.

Previously, the limited bandwidth of communication links to aircraft has not been an issue because the Federal Communications Commission (“FCC”) prevented users from operating wireless devices on aircraft due to concern that the wireless device may interfere with aircraft instruments. However, after extensive testing, the FCC has determined that some wireless devices do not interfere with the aircraft instruments. Accordingly, the FCC has started to approve use of wireless devices aboard aircraft for in-flight use. One approved device is a wireless network interface card that connects, for example, computers to wireless networks with wireless fidelity (“WiFi”).

### BRIEF DESCRIPTION OF THE DRAWINGS

FIG. 1 is a schematic illustration of a system to cache content on a vehicle.

FIG. 2 is a more detailed schematic illustration of an example content identifier of FIG. 1.

FIG. 3 is a schematic illustration of an example apparatus to implement a network on a vehicle through the use of cached content.

FIG. 4 is an illustrative example of an interface a passenger may use to access contents on the vehicle network.

FIG. 5 is a flowchart representative of example processes that may be executed to implement the passenger identifier of FIG. 1.

FIG. 6 is a flowchart representative of example processes that may be executed to implement the content identifier of FIG. 2.

FIG. 7 is a flowchart representative of example processes may be executed to implement the download routine of FIG. 6.

FIG. 8 is a flowchart representative of example processes that may be executed to implement the content controller of FIG. 3.

FIG. 9 is a schematic illustration of an example processor platform that may execute the example processes of FIGS. 5, 6, and 7 to implement the apparatus of FIGS. 1 and 2, and that may execute the example process of FIG. 8 to implement the content controller of FIG. 3.

### DETAILED DESCRIPTION

As described above, network bandwidth to and from a vehicle during transit is extremely limited, especially when considering the number of passengers a vehicle can carry and the passengers' attendant desire for bandwidth. As explained below, a method and system of caching content on a vehicle is described herein.

In the following examples, methods and apparatus to cache content on a vehicle are disclosed. Although the following focuses on an example of caching content on an aircraft, such as a commercial passenger airplane, the description is not limited to use with aircraft. On the contrary, the disclosure extends to all environments of use in which caching content for consumption during transit is useful. For example, the teachings of this disclosure can be adjusted to cars, trains, watercraft (e.g., cruise ships), military vehicles, buses, and/or any other type of vehicles.

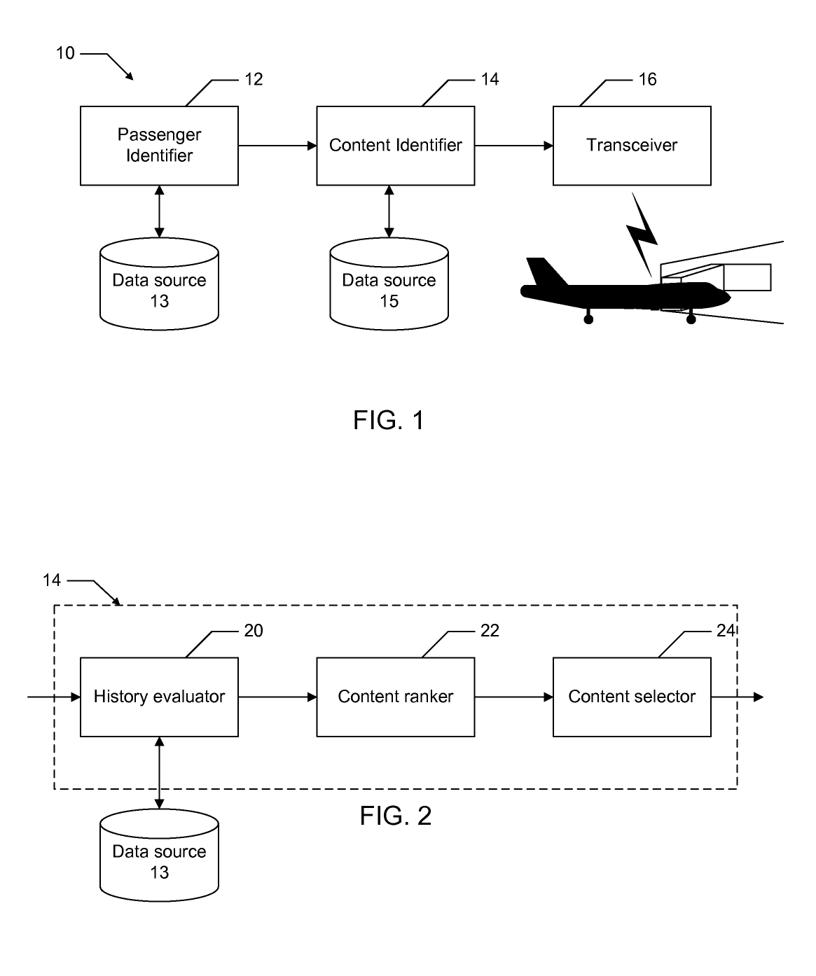

FIG. 1 is an illustration of an example system 10 to cache content for an upcoming trip on a vehicle. For the purpose of identifying passengers for an upcoming trip, such as air travel, the system 10 is provided with a passenger identifier 12. Before the trip, the passenger identifier 12 may identify the vehicle's passengers for the trip by using a unique identifier associated with each passenger. The unique identifier may be, but is not limited to, a frequent flyer number, a reservation number, an email address, a credit card number, an account number, and/or a passenger name. A person having ordinary skill in the art will readily appreciate that many other unique identifiers can be used to identify passengers. In one example, the passenger identifier 12 may identify the passengers from a data source 13. The data source 13 may be of any type of relevant data source, including, but not limited to a manifest list, travel reservation system, and/or a proprietary database. Additionally or alternatively, unique identifiers may be keyed directly into the passenger identifier 12 by hand using a keyboard or any other suitable interface device.

To identify content of interest to a passenger, a content identifier 14 is further provided in the example system 10. The content identifier 14 receives passenger identification information from the passenger identifier 12 and, based on that passenger identification, may locate a passenger's profile in a data source 15. The data source 15 may be of any type of relevant data source, for example, a proprietary database that includes each passenger's content request history. The content identifier 14 may then evaluate each passenger's content request history to identify particular content of interest to at least one passenger. The content of interest to passengers may include both public and private information. In other words, the content of interest may be of interest to all passengers or it may be of interest to a particular passenger. For example, the content of interest may be a movie, it may be a specific passenger's email, or it may be a specific website such as www.gizmodo.com. The data source 15 may include a plurality of sources that may be aggregated for the passenger's content requests. For example, a first data source may be an account associated with the AT&T Yahoo!™ web portal and a second data source may be an account associated with AT&T Cingular™ mobile network.

To transmit the content of interest from an example system 10 to the vehicle, a transceiver 16 may be included. The transceiver 16 may be any type of communications device capable of delivering content to and receiving content from the vehicle. For example, the transceiver 16 may be an 802.11 wireless network, a WiMax base station, a cellular base station (e.g. EV-DO, EDGE/HSDPA, etc.), a satellite, a local Ethernet network link, or any other system using wired or wireless transmission. As illustrated in the example of FIG. 1, prior to departure of the vehicle, a portion of the content of interest may be transmitted to the vehicle based on one or more caching priorities via the transceiver 16. For example, the content with a first caching priority may be assigned a higher priority for transmission to the vehicle than the content with a second caching priority. However, it would be readily apparent a person having ordinary skill in the art to transmit a portion of the first caching priority and a portion of the second priority at the same time.

For the purpose of prioritizing content for presentation to the passengers, the example system 10 may evaluate additional information in a passenger's historical information. In the example of FIG. 2, the content identifier 14 may include a history evaluator 20 to evaluate the passengers' content request history for the purpose of prioritizing content of interest for the passengers. For example, the history evaluator 20 may evaluate each passenger's purchase history, device access history (i.e., whether the passenger used laptop, smartphone, personal digital assistant (PDA), or similar device to access the content), content request history, or any other historical information.

The content identifier 14 may also include a content ranker 22 to rank the content of interest based on the evaluation of the passengers' historical data (which, as described above, is found in a passenger profile in the data source 15). For instance, the content identifier 14 may find that one exemplary passenger only requests content when the travel time is greater than two hours, and, therefore, during a trip that lasts one hour, the content identifier 14 will rank that passenger's content requests low because the passenger is unlikely to access that content. In another example, the content identifier 14 may identify patterns of content request. For example, the content identifier 14 may determine that a passenger checks the stock market performance at specific intervals during the day. If one such time period occurs while the vehicle is in transit, the content identifier 14 may rank the passenger's content request for the content high because the passenger is more likely to access the content.

In the example of FIG. 2, content identifier 14 may prioritize download of content to the vehicle by operation of a content ranker 22. In one example, the content ranker 22 may use multiple factors to rank the content of interest. Some of these factors may include, but are not limited to passengers' purchase history, content data size, and passengers' content request history. Another example factor may be profit margin, which may be any computation of profit such as, but not limited to, profit margin, gross profit margin, net profit margin, and/or an estimated profit gross based on passenger interest. For example, the content identifier 14 may compute profit based on net sales per data size in kilobytes. Based on an analysis of at least one of the factors described above, the content ranker 22 computes a priority score for each content item in the content of interest. For example, the content ranker 22 may compute a priority scored based on a customer purchase propensity score (e.g., the likelihood a passenger would purchase access to the content) multiplied by profit margin per kilobyte. Additionally, the priority score may be based on the aggregate interest level of the passengers. For example, a new movie release may have a higher priority score based on the content request history of one or more passengers in the vehicle. Next, the content in the content of interest is ranked in descending order based on the priority score of the content (i.e., content with a higher priority score will have a higher rank).

In addition to the content of interest, the content identifier 14 may also include baseline content for the passengers. For example, the baseline content may include electronic versions of new sources, movies, television programs, websites, audio programs, games, interactive programs, documents in electronic format (e.g., e-books, PDF versions of print sources, etc), or any other content of interest to the passengers. The baseline content may be associated with a first caching priority and the content of interest identified from passenger profiles may be associated with a second caching priority (e.g., the priority rank is the second caching priority).

In one example, after all content has been identified in the content ranker 22, control proceeds to the content selector 24. The content selector 24, for example, selects the content of interest to cache on the vehicle based on the priority rank (e.g., content with the highest priority score will be selected first). Generally, the example will secure the baseline content of interest for the passengers. While the example transmits updated content to the vehicle, the example will also purge old content and replace it with newer versions of the same content. For instance, the example system 10 may replace an older electronic version of The New York Times with a newer electronic version. The example system 10 may also receive information from the vehicle via the transceiver 16 (e.g., the vehicle may transmit the passenger content request history of the previous flight to the example system 10 for storage in the data source 15).

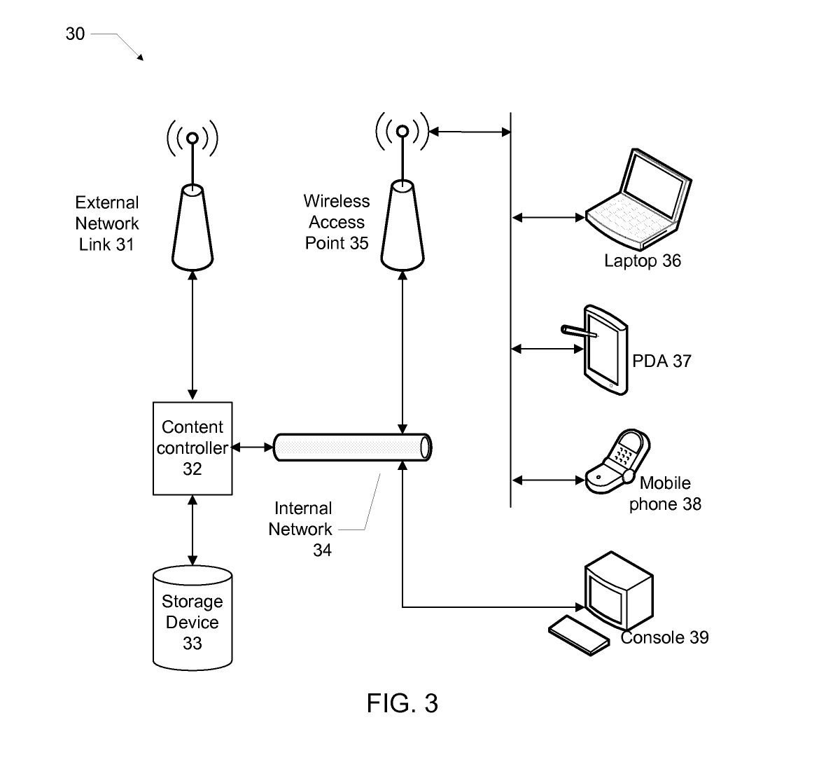

FIG. 3 illustrates an example vehicle network 30 including cached content. For the purpose of providing external network access from the vehicle, an external network link 31 is provided. The external network link provides communication services to passengers via terrestrial or extra-terrestrial communication links. For example, the external network link 31 may be a series of ground based tower providing wireless communications to and from the vehicle. In another example, the external network link 31 may be coupled to a satellite for sending and receiving communications. The external network link 31 further sends and receives data to and from the external network, thereby allowing passengers to access communication services outside of the vehicle during transit. Additionally, while the vehicle is docked at an airport terminal, the external network link 31 may be coupled to an external network via a wired communication link to provide passengers external network access before departing on the trip.

The external network link 31 may be coupled to a content controller 32 for the purpose of routing network data and caching content. In one example, content is cached in the storage device 33 prior to the departure of the vehicle. For example, content may be cached in a commercial airliner while the vehicle is being prepared for its next trip. To save bandwidth to and from the external network link 31, the cached content is served to passenger devices via the content controller 32. In one example, when a passenger device requests content, the content controller 32 will determine if the requested content is cached in the storage device 33 before requesting content via the external network link 31. For instance, a passenger may request “www.nytimes.com” from his laptop during transit. The content controller 32 receives the request and determines if “www.nytimes.com” is cached in the storage device 33. If “www.nytimes.com” is cached, the content controller 32 retrieves the requested content from the storage device 33 and then serves the requested content to the passenger device. If the storage device 33 has not cached the requested content, the content controller 32 may retrieve the requested content via the external network link 31 and served the requested content to the passenger drive. Alternatively, the content controller 32 may cache the requested content within the storage device 33 retrieved via the external network before serving the requested content to the passenger. Additionally, the content controller 32 may selectively allow access to the cached content and/or the external content via the network link 31. In one example, a passenger may purchase access to the cached content for one price or may purchase access to external content for a second price. In another example, a passenger may be granted access to cached content via the content controller 32 that is supported by advertisements. In other words, the passenger may be presented advertisements while consuming a portion of the cached content.

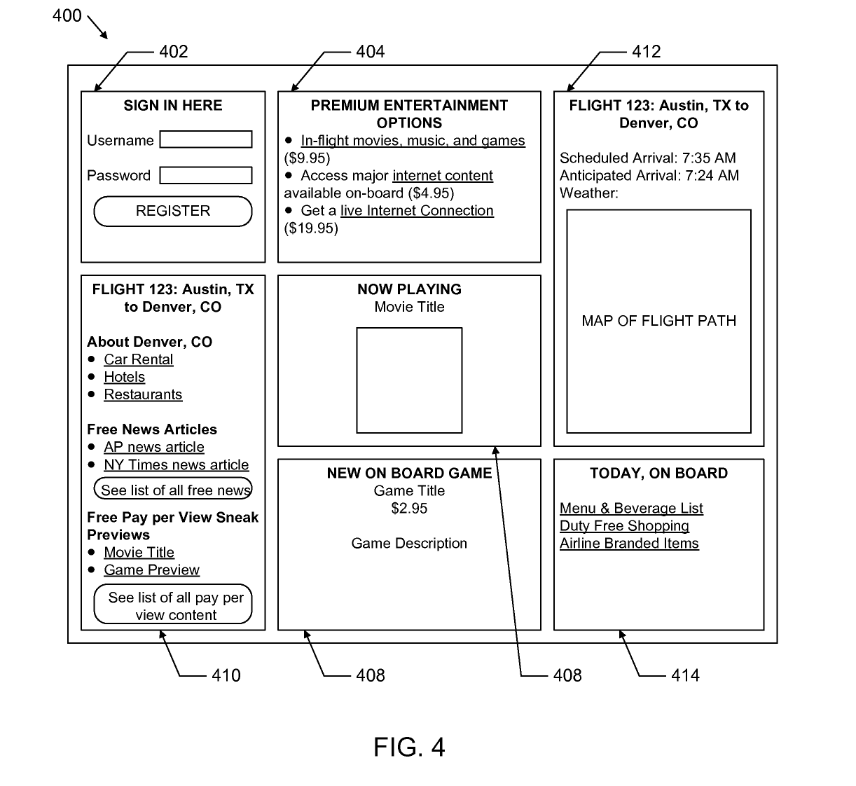

For the purpose of routing content between devices in the vehicle, the content controller 32 is coupled with an internal network 34. The content controller 32 may selectively route network data between electronic devices in both the internal network 34 and an external network. In other words, the content controller 32 selectively allows access between devices in the internal network 34. In one example, the content controller 32 allows network access to the internal network 34 based on the network credentials, which are determined by the content controller 32. For example, if a passenger using a laptop has not paid for network access, the content controller 32 may prevent the passenger from sending and receiving network data in the internal network 34. However, in the example, if the passenger has paid for access to network services, the content controller 32 may send and receive network requests from the passenger's laptop and route the network request accordingly. As described below, FIG. 4 illustrates an example interface that may allows a passenger to login and/or pay for network access in the vehicle. Persons having ordinary skill in the art will readily recognize the example is one method in which network access may be given to passengers.

The passengers may be provided network connectivity by either wireless or wired networking. For example, a wireless network link 35 may be coupled to the internal network 34 to provide network access to passenger devices. In the example of FIG. 3, passenger devices such as a laptop 36, a PDA 37, and/or a mobile phone 38 may connect to the internal network 34 via the wireless network link 35. A person having ordinary skill in the art will recognize the described passenger devices are merely exemplary and are not the only devices capable of utilizing the vehicle network 30. The wireless network link 35 may be any type of wireless link, such as, but not limited to, an 802.11 (b), (g) or (n) wireless network, a WiMax network link, or a Bluetooth network link.

Access to the internal network 34 may also be provided via direct network connection to the internal network 34. For example, the console 39 is coupled to the internal network 34 via a direct network connection (e.g., an Ethernet connection, etc). Accordingly, a person having ordinary skill in the art will appreciate that network connectivity to any electronic devices in the vehicle may be coupled to the internal network 34 either via wired communication or wireless communication. For example, a passenger using the laptop 36 may connect to the internal network 34 via a direct Ethernet network connection. Alternatively, the same passenger may use the laptop 36 to connect to the internal network via a wireless communication link 35.

In addition, the content controller 32 may support multiple tiers of service. The tiers of service allow for different levels of access to network services and content cached on storage device 33 via the content controller 32. In one example, content controller 32 might have three tiers of service: a first tier offers only basic news and specialized content for the passenger cached in the storage device 33, a second tier offers basic news and access to multimedia (e.g., movies, television programs, video on demand, audio programs, etc) stored in the storage device 33, and a third tier offers access to all cached content in the storage device 33 and network access to the external network. A person having ordinary skill in the art will readily appreciate that the described example is merely illustrative and that any number of services may be configured for the content controller 32. For example, one tier of service may be advertisement supported, which allows passengers free access to content that is presented with advertisements in the content.

To provide updated information to the passengers, the content controller 32 may also support incremental refreshing of cached content. In such an example, the content controller 32 selectively retrieves the content via the external network link 31 at time intervals. Once updated content is retrieved via the external network, the example caches the content in the storage device 33 for access by the passengers. For example, the passengers may be in transit during a popular sporting event and the content controller 32 may refresh selected portions of the content during transit. Depending on the type of content, the content controller 32 may either purge the stale content (e.g., a web page being updated frequently) or may supplement the stale content (e.g., a sporting event which is being downloaded to the vehicle in increments). A person having ordinary skill in the art will readily appreciate example system 10 is exemplary and in addition, any type of content, including multimedia, web pages, or any other type of content, may be incrementally retrieved and cached according to the teachings of the example.

FIG. 4 illustrates an example interface 400 that a passenger may be presented to upgrade network credentials associated with the passenger device. In the example of FIG. 4, passenger name may create and login into the network for access to the content available on the vehicle (block 402). Furthermore, the passenger may select from multiple entertainment and internet content (block 404). If the passenger does not need extensive content, the passenger may also select individual items of content such as a pay per view movie (block 406) or a multimedia game (block 408). Additionally, the passenger may select from free content such as new articles, content associated with the vehicle destination, and/or sneak previews of content (block 410). In one example, the example interface 400 may also include flight information and an in-flight map (block 412).

Persons of ordinary skill in the art will readily recognize that methods and apparatus to cache content on a vehicle described herein may be utilized for any distribution facilities implemented using any type(s) and/or any combination(s) of cabling, devices and/or topology. Accordingly, the example system 10 and the vehicle network 30 are merely illustrative examples.

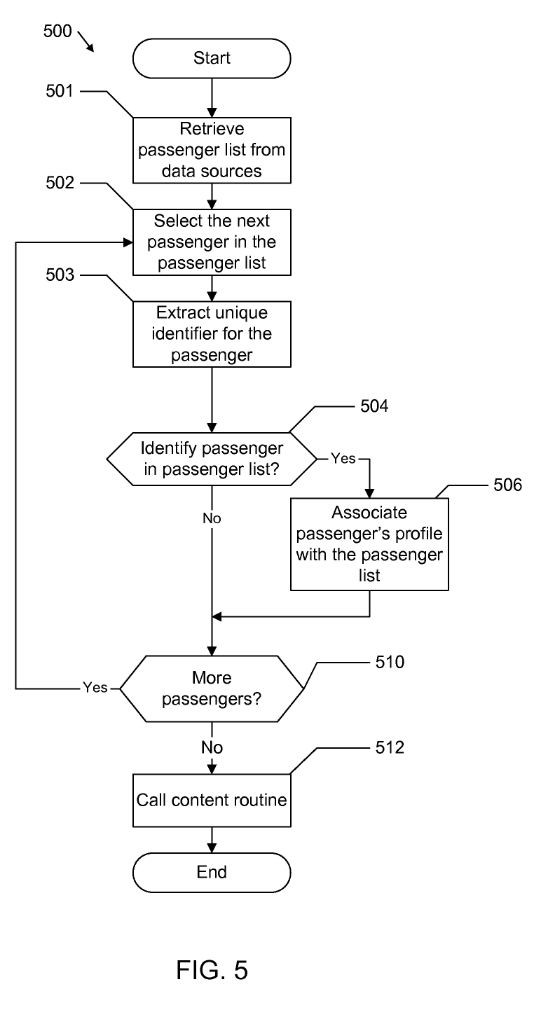

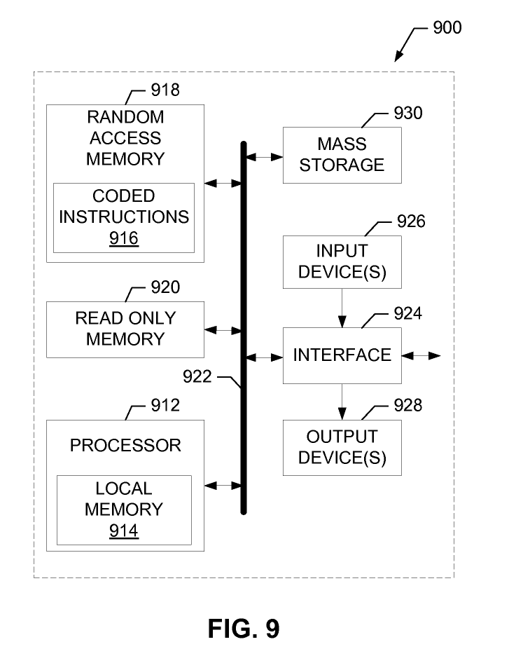

Flowcharts representative of example processes for implementing the example system 10 of FIG. 1 are shown in FIGS. 5, 6, and 7. In this example, the processes may be implemented using machine readable instructions such as a program for execution by a processor such as the processor 912 shown in the example computer 900 discussed below in connection with FIG. 9. The processes may be embodied in software stored on a tangible medium such as a CD-ROM, a floppy disk, a hard drive, a digital versatile disk (DVD), or a memory associated with the processor 912, but persons of ordinary skill in the art will readily appreciate that the entire process and/or parts thereof could alternatively be executed by a device other than the processor 912 and/or embodied in firmware or dedicated hardware in a well known manner. For example, any or all of the passenger identifier 12, the content identifier 14, and/or the transceiver 16 could be implemented by software, hardware, and/or firmware. Further, although the example processes are described with reference to the flowcharts illustrated in FIGS. 5, 6, and 7, persons of ordinary skill in the art will readily appreciate that many other methods of implementing the example system 10 may alternatively be used. For example, the order of execution of the blocks may be changed, and/or some of the blocks described may be changed, eliminated, or combined.

The process 500 of FIG. 5 is an illustrative example process that may be carried out by or to implement the passenger identifier 12. The example process 500 begins by retrieving a passenger list from at least one data source (block 501). The data source 13, as described above, may be from a passenger manifest list, a travel reservation system (e.g., SABRE, Amadeus, and/or WORLD SPAN), or a proprietary database. The example process 500 begins to identify each passenger in the passenger list (block 502). This operation occurs by selecting the next passenger on the passenger list (block 502) and extracting a unique identifier for the passenger (block 503).

The unique identifiers extracted at block 503 include, but are not limited to, frequent flyer number, credit card number, email address, passenger name, and/or phone number. Using the unique identifiers extracted at block 503, the example program attempts to identify the passenger by associating the passenger with a passenger profile located in a data source 15, which may be a private data source (block 504). If the passenger is identified at block 504 with at least one of the unique identifiers, the example process 500 associates the passenger profile with the passenger list (block 506).

After the association (block 506) or if no passengers are identified (block 504), the example process 500 determines if there are any more passengers on the passenger list (block 510). If more passengers are in the passenger list (block 510), the next passenger is selected (block 502). Thus, the example process 500 continues a loop that repeats blocks 502 through 510 until all passengers with a passenger profile are associated with their corresponding passenger profile in data source 15. When it is determined that there are no more passengers (block 510), the content identifier 14 is started (block 512).

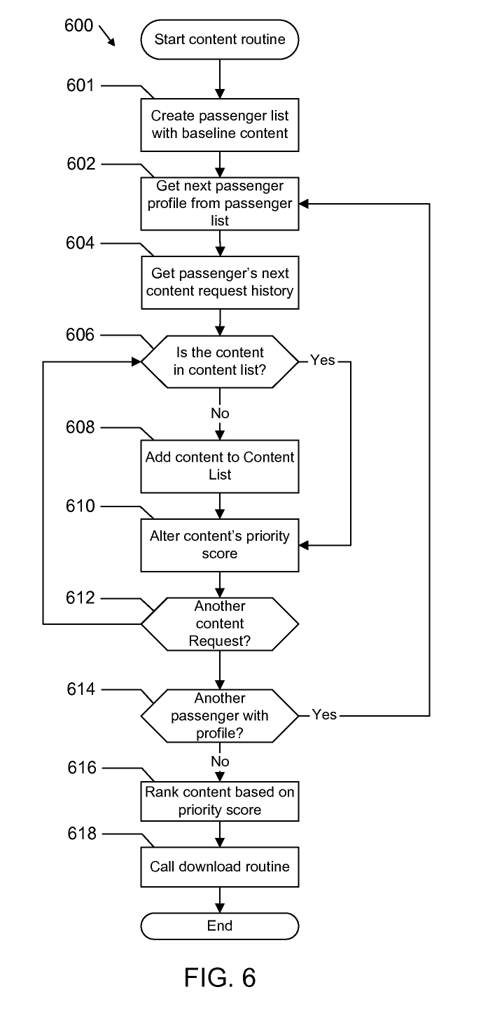

FIG. 6 is illustrative of an example process 600 that may be carried by the content identifier program 14. The example process 600 creates a content list with baseline content, which may be assigned a first caching priority (block 601). The baseline content is content of general interest to the passengers, for example, websites such as www.nytimes.com or www.wallstreetjournal.com, recently released movies, selective television programs, or any other type of content that the passengers may be interested in. Next, the example process 600 selects the next passenger with an associated passenger profile from the passenger list (block 602) and selects the passenger's next historical content request (block 606).

If the content request is not found in the content list, the example process 600 adds the content request to the content list (block 608). After adding the content request to the content list or if the content request is found in the content list, the example process 600 alters the content's priority score (block 610) based on at least one factor. For example, the example process 600 may alter the priority score based on the passenger's purchase history, data size of the content, popularity of the content, and/or the profit of the content. Persons having ordinary skill in the art will readily appreciate that any number of factors may be used in the computation of the priority score.

After the priority score has been adjusted, the example process 600 determines if the passenger's profile includes additional historical content requests (block 612). If there are additional content requests, the example process 600 returns to block 606. Thus, the example process 600 continues a loop that repeats between block 606 and 612 until all of the passenger's historical content requests have been either added to the list and/or the content's priority score is adjusted. After all of the passenger's content requests have evaluated, the example process 600 determines if there are any more passengers in the passenger list with an associated profile (block 614). If additional passengers have an associated profile (block 614), the example process 600 selects the next passenger with a profile (block 602). Thus, the example process 600 repeats a loop between block 602 and block 614 until all of the passengers with associated profiles have been evaluated for content requests.

After all of the passenger profiles have been evaluated for content requests, the example process 600 ranks the content of interest based on the content's priority score (block 616). In other words, the content is ranked in descending order based on the content's priority score. Control of the example process 600 then calls the download process (block 618).

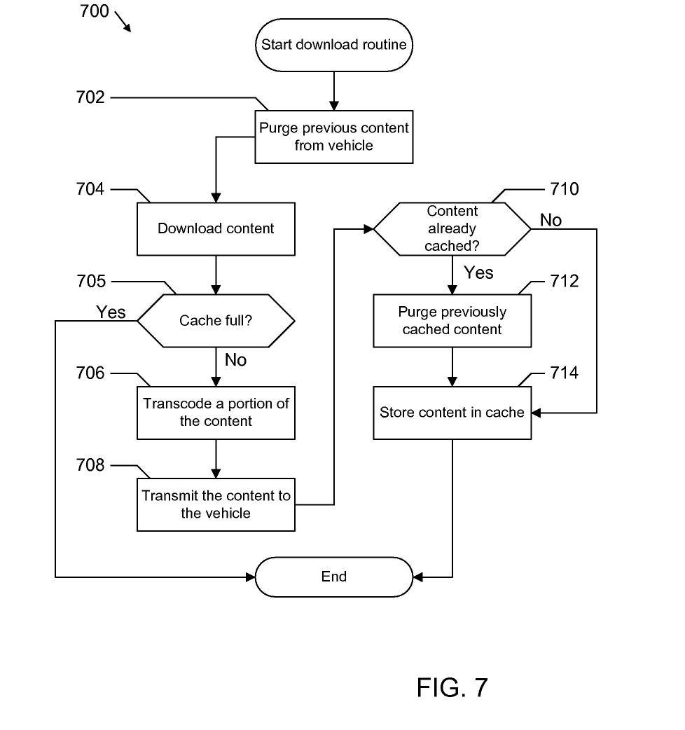

FIG. 7 illustrates an example download process 700 of FIG. 6 (block 618). Initially, the example process 700 purges cached content that is specific to passengers of the previous trip (block 702) and then begins to download the content (block 704). The example process 700 may retrieve the content with the first caching priority (e.g., the baseline content) before the content with the second caching priority (e.g., the content of interest). However, the example process 700 may retrieve a portion of the content with the second caching priority at the same time. Once all baseline content is downloaded, the example process 700 may download the content of interest based on the content rank provided in FIG. 6. However, for the purpose of downloading the most content of interest, the example process 700 may download content with a lower rank if the higher ranking content is not available. For example, if one content item is not be accessible due to a slow network connection and the example process 700 may instead choose to retrieve a content item with a lower rank due to a better network connection.

As the content is downloaded, the example process 700 determines if the cache is full (block 705). If the cache is full, the example process 700 ends. If the cache is not full, the example process 700 may transcode the content for a first device and/or a second device (block 706). For example, a multimedia movie may be transcoded into a format that a laptop will be able to view. However, the transcoded movie for the laptop would not be appropriate for another passenger's smartphone. Accordingly, the example process 700 may transcode the movie for playback on the second passenger device (e.g., a smart phone, a PDA, a mobile phone, etc). Alternatively, to save on storage size in the cache, the transcoding may occur on the vehicle. After any transcoding, the example process 700 transmits the content to the vehicle (block 708). Once the content is on the vehicle, the example process 700 determines if the content is already cached (block 710) and purges the previously cached content (block 712). Once the stale content is purged or if the content was not previously cached, the content is stored in the cache (block 714).

The transmission of data from the example process 700 continues until all of the content have been received, the cache is full, or until the vehicle embarks on the trip. As described above, the transceiver 16 may send and receive network communications via a wired or wireless communication link (e.g., an 802.11(b) or 802.11 (n) wireless network, a WiMax base station, a UMTS base station, a local Ethernet network link, etc).

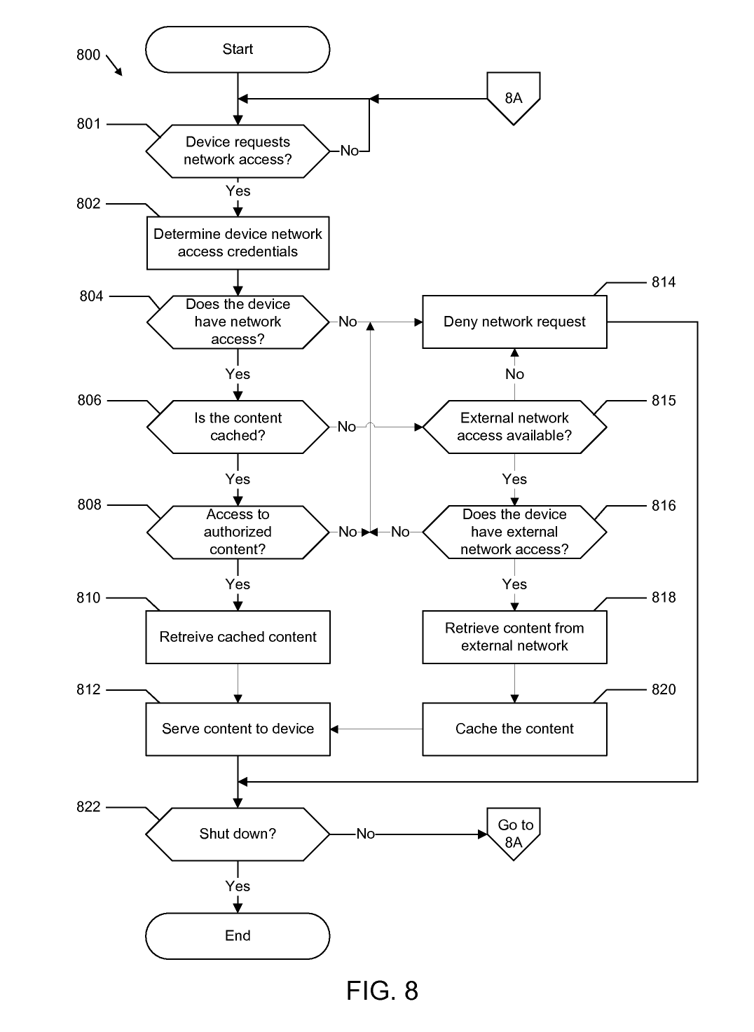

The process of FIG. 8 is an illustrative example process 800 that may be carried out by or to implement the example vehicle network 30 described in FIG. 3. The example process 800 waits for a passenger device to request access to the network (block 801). The passenger device may be any device that can connect to a communication network (e.g., a laptop, mobile phone, PDA, or smartphone). Once a passenger requests network access, the example process 800 determines the network access credential associated with the passenger device (block 802).

If the passenger's device does not have network access credentials to access the network, the example process 800 denies the network request (block 814). In denying the request, the example process 800 may display a form and allow the passenger to obtain network access credentials in order to access the network (e.g., see FIG. 4). If the passenger device is associated with sufficient network credentials, the example process 800 checks to see if the content is cached locally (i.e., whether the content is cached on the vehicle's network) (block 806). If the content is cached locally, the example process 800 determines if the passenger device has sufficient network credentials to access the content (block 808). If the passenger device does not have sufficient network credentials, the passenger's network access is denied (block 814). However, if the passenger device has sufficient network credentials, the example process 800 retrieves the cached content (block 810) and serves the content to the passenger device (block 812).

If the content is not cached (block 806), the example process 800 determines if there is access to an external network (block 815). If there is no external network, the network request is denied (block 814). When it is determined that there is external network access (i.e., the passenger has purchased network credentials to access the external network), the example process 800 next determines if the passenger device has sufficient network credentials to access the external network (block 816). If the passenger device does not have sufficient network credentials to access the external network, the network request is denied (block 814). In the case the passenger device has sufficient network credentials to access the external network, the example process 800 retrieves the content of the network request via the external network (block 818). Once the content is retrieved, the content is cached (block 820) and then served to the passenger device (block 812).

In the event that a passenger device is denied a network request at block 814, the passenger may be presented the opportunity to upgrade the network credentials of the passenger device (i.e., the passenger device is presented an interface as illustrated in FIG. 4). In one example, the passenger may obtain or upgrade the network credentials by creating a profile and paying a fee. As illustrated in the example of FIG. 4, the passenger may select multiple grades of service that are available at different costs or may select individual portions of content (e.g., a game, a specific movie, an audio program, etc).

Once a passenger device has been denied the content (block 814) or the content has been served to the passenger device (block 812), the network request is complete. The example process 800 determines if a shut down command has been issued (block 822), and if not, returns to block 801 to wait for the next network request. If a shutdown command has been issued, the example process 800 ends. Thus, the example process 800 repeats a loop from block 801 through block 822 until a shutdown command has been issued and the example process 800 ends.

FIG. 9 is a block diagram of an example computer 900 capable of implementing the apparatus and methods disclosed herein. The computer 900 can be, for example, a server, a personal computer, a PDA, an Internet appliance, a DVD player, a CD player, a digital video recorder, a personal video recorder, a set top box, or any other type of computing device.

The system 900 of the instant example includes a processor 912 such as a general purpose programmable processor. The processor 912 includes a local memory 914, and executes coded instructions 916 present in the local memory 914 and/or in another memory device. The processor 912 may execute, among other things, the example machine readable instructions illustrated in FIGS. 4, 5, and 6. The processor 912 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate. (Note: need to change all #'s in this section—once drawings are finalized)

The processor 912 is in communication with a main memory including a volatile memory 918 and a non-volatile memory 920 via a bus 922. The volatile memory 918 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 920 may be implemented by flash memory and/or any other desired type of memory device. Access to the main memory 918, 920 is typically controlled by a memory controller (not shown) in a conventional manner.

The computer 900 also includes a conventional interface circuit 924. The interface circuit 924 may be implemented by any type of well known interface standard, such as an Ethernet interface, a universal serial bus (USB), and/or a third generation input/output (3GIO) interface.

One or more input devices 926 are connected to the interface circuit 924. The input device(s) 926 permit a user to enter data and commands into the processor 912. The input device(s) can be implemented by, for example, a keyboard, a mouse, a touchscreen, a track-pad, a trackball, isopoint and/or a voice recognition system.

One or more output devices 928 are also connected to the interface circuit 924. The output devices 928 can be implemented, for example, by display devices (e.g., a liquid crystal display, a cathode ray tube display (CRT), a printer and/or speakers). The interface circuit 924, thus, typically includes a graphics driver card.

The interface circuit 924 also includes a communication device (e.g., interface circuits 914) such as a modem or network interface card to facilitate exchange of data with external computers via a network (e.g., an Ethernet connection, a digital subscriber line (DSL), a telephone line, coaxial cable, a cellular telephone system, etc.).

The computer 900 also includes one or more mass storage devices 930 for storing software and data. Examples of such mass storage devices 930 include floppy disk drives, hard drive disks, compact disk drives and digital versatile disk (DVD) drives. The mass storage device 930 may implement the local storage device 720.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

To the extent the above specification describes example components and functions with reference to particular standards and protocols, it is understood that the scope of this patent is not limited to such standards and protocols. For instance, each of the standards for Internet and other packet switched network transmission (e.g., Transmission Control Protocol (TCP)/Internet Protocol (IP), User Datagram Protocol (UDP)/IP, HyperText Markup Language (HTML), HyperText Transfer Protocol (HTTP)) represent examples of the current state of the art. Such standards are periodically superseded by faster or more efficient equivalents having the same general functionality. Accordingly, replacement standards and protocols having the same functions are equivalents which are contemplated by this patent and are intended to be included within the scope of the accompanying claims.

This patent contemplate examples wherein a device is associated with one or more machine readable mediums containing instructions, or receives and executes instructions from a propagated signal so that, for example, when connected to a network environment, the device can send or receive voice, video or data, and communicate over the network using the instructions. Such a device can be implemented by any electronic device that provides voice, video and/or data communication, such as a telephone, a cordless telephone, a mobile phone, a cellular telephone, a Personal Digital Assistant (PDA), a set-top box, a computer, and/or a server.

Additionally, although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, persons of ordinary skill in the art will readily appreciate that the examples are not the only way to implement such systems, methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method of caching content on a vehicle, the method comprising:
identifying a passenger for an upcoming ride on the vehicle;
identifying content of interest for the passenger; and
transmitting at least a portion of the content of interest to a storage device carried by the vehicle for caching prior to a beginning of the trip.

2. A method as defined in claim 1, wherein identifying the passenger comprises obtaining a frequent flyer number from a passenger list for the upcoming trip.

3. A method as defined in claim 1, wherein the content of interest comprises general content of interest to at least one other passenger and specific content of interest to the passenger.

4. A method as defined in claim 3, wherein the general content of interest is assigned a first caching priority, the specific content of interest is assigned a second caching priority, and the first caching priority is higher than the second caching priority.

5. A method as defined in claim 4, wherein the at least the portion of the content of interest is selected based on at least one of the first and second caching priorities.

6. A method as defined in claim 4, wherein the specific content of interest is ranked by an interest probability.

7. A method as defined in claim 6, wherein the rank is computed by interest probability based on the purchase history of the passenger, the access history of the passenger, and/or the profit of the specific content of interest.

8. A method as defined in claim 1, wherein the content of interest is transcoded to serve a first type of device and a second type of device, the first and second devices being different.

9-13. (canceled)

14. An apparatus for caching content on a vehicle, the system comprising:
a passenger identifier to identify a passenger for an upcoming ride on the vehicle; and
a content identifier to identify content of interest for the passenger based on historical access activity of the passenger; and
a transmitter to transmit at least a portion of the content of interest to a storage device carried by the vehicle for caching prior to a beginning of the ride.

15. An apparatus as defined in claim 14, wherein the passenger identifier identifies the passenger by a unique identifier.

16. An apparatus as defined in claim 15, wherein the unique identifier is the passenger's frequent flyer number.

17. An apparatus as defined in claim 14 further comprising a transcoder, wherein the transcoder transcodes a portion of the content of interest for a first type of device and/or a second type of device.

18. An apparatus as defined in claim 14, wherein the content identifier further identifies a baseline portion of the content of interest for the passenger.

19. An apparatus as defined in claim 14, wherein the transmitter transmits a portion of the content of interest to the vehicle based on a priority score given by the content identifier.

20. An apparatus as defined in claim 19, wherein the priority score is based on a purchase history of the passenger.

21. An apparatus as defined in claim 19, wherein the priority score is based on an access history of the passenger.

22. An apparatus as defined in claim 19, wherein the priority score is based on a profit margin of the content of interest.

23-30. (canceled)

31. An article of manufacture storing machine readable instruction which, when executed, cause a machine to:
identify a passenger for an upcoming ride on the vehicle;
identify content of interest for the passenger; and
transmit at least a portion of the content of interest to a storage device carried by the vehicle for caching prior to a beginning of the ride.

32. An article of manufacture as defined in claim 31, wherein the passenger is identified by a unique identifier from a passenger list for the upcoming trip.

33. An article of manufacture as defined in claim 32, wherein unique identifier is a frequent flyer number.

34. An article of manufacture as defined in claim 32, wherein unique identifier is a credit card number.

35. An article of manufacture as defined in claim 31, wherein the content of interest comprises general content of interest to at least one other passenger and specific content of interest to the first passenger.

36. An article of manufacture as defined in claim 31, wherein the general content of interest is assigned a first caching priority, the specific content of interest is assigned a second caching priority, and the first caching priority is higher than the second caching priority.
